(19) United States
(12) Patent Application Publication
(10) Pub. No.: US 2012/0044429 A1
(43) Pub. Date: Feb. 23, 2012

(54) DIGITAL DISPLAY DEVICE SYSTEM

(76) Inventor: Louis Sean Guerra, Saratoga Springs, NY (US)

(21) Appl. No.: 12/858,968

(22) Filed: Aug. 18, 2010

(51) Int. Cl. H04N 5/64

(52) U.S. Cl. 348/837

(57) ABSTRACT

A digital display device system includes a digital display and a receiving port disposed on a front bumper of a vehicle. Said digital display may be positioned at a desired height with respect to the bumper by using a mounting device that includes a brace, male-mount and a female receiving port. The system may include a controller for inputting information to be displayed on the digital display. The system may display user desired digital images or messages with the default digital image being vehicle identification information specific to the vehicle on which the digital display is disposed.

### FIELD OF THE INVENTION

The present invention relates to display device systems for vehicles. More particularly, the present invention relates to a digital license plate system including a digital display that is removably attachable to a vehicle.

### BACKGROUND OF THE INVENTION

Car aficionados have a wide variety of accessories that draw attention to one's vehicle. Such accoutrements include high-end car rims, elaborate details in bumpers or finishes, and even high-tech lighting and/or sound systems. However, vehicle license plates are one type of accessory that has had little advancements in terms of embellishments. To date, embellishments for license plates largely involve decorative license plate holders or personalized license plates. A digital license plate display device is desired that would allow vehicle owners to customize license plates using digital images. Accordingly, a need exists for a display device system that can display custom digital images or digital messages. A display device system is also required that can be easily installed and easily removed when desired.

### BRIEF SUMMARY OF THE INVENTION

A display device system includes a digital display device that can be removably attached to a front end of a vehicle. The display device has a mounting device on its rear surface which includes a brace and a male-mount that slidably connects to the brace. The male-mount of the display is receivable within a female receiving port that is disposed on a front end of the vehicle. The female port is dimensioned and configured to receive the male-mount of said display device. The digital display can display digital images, messages and vehicle identification information such as a license plate number. A controller may be used to manage the information displayed on the digital display device.

### BRIEF DESCRIPTION OF THE DRAWING

FIG. 1 shows a display device system of the present invention including a digital display and a receiving port.

FIG. 2 shows a rear view of the digital display shown in FIG. 1.

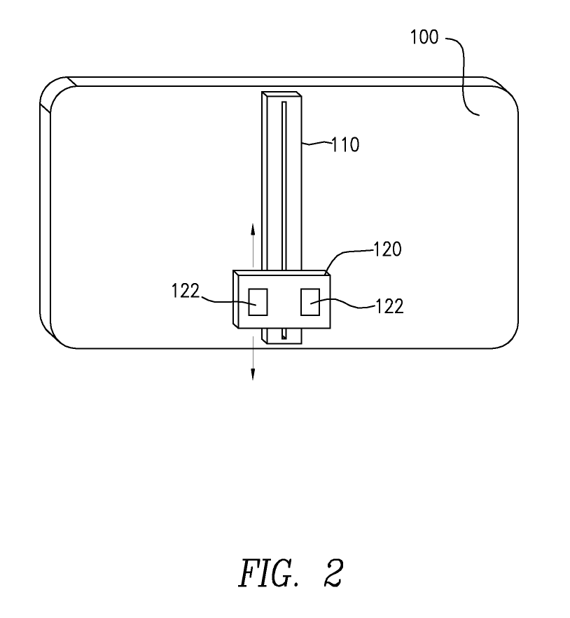

FIG. 3 shows a side view of the display device system of the present invention.

FIG. 4 shows a view of a control panel of the display device system of the present invention.

### DETAILED DESCRIPTION OF THE INVENTION

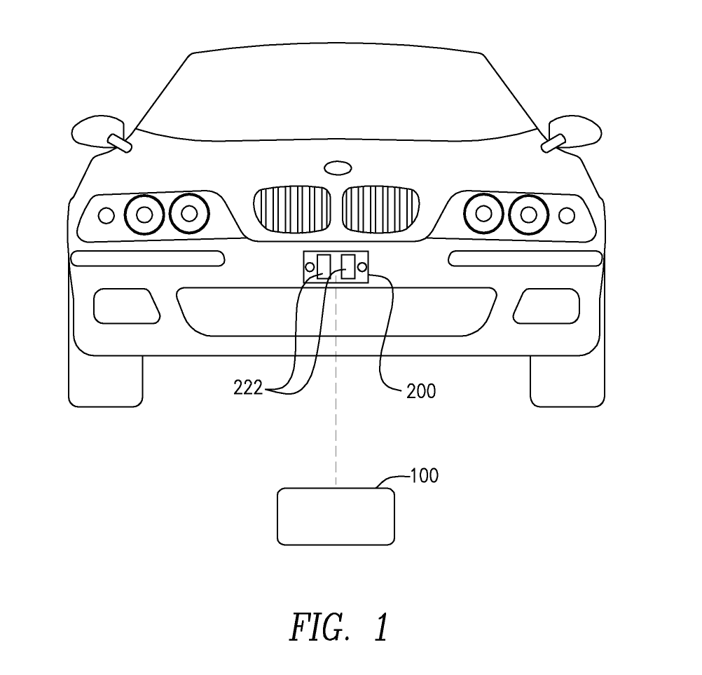

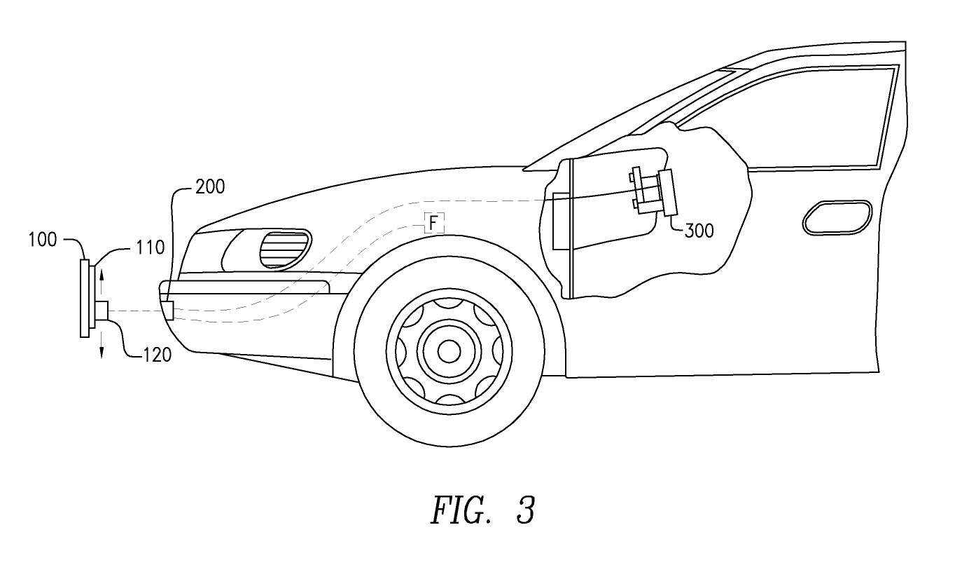

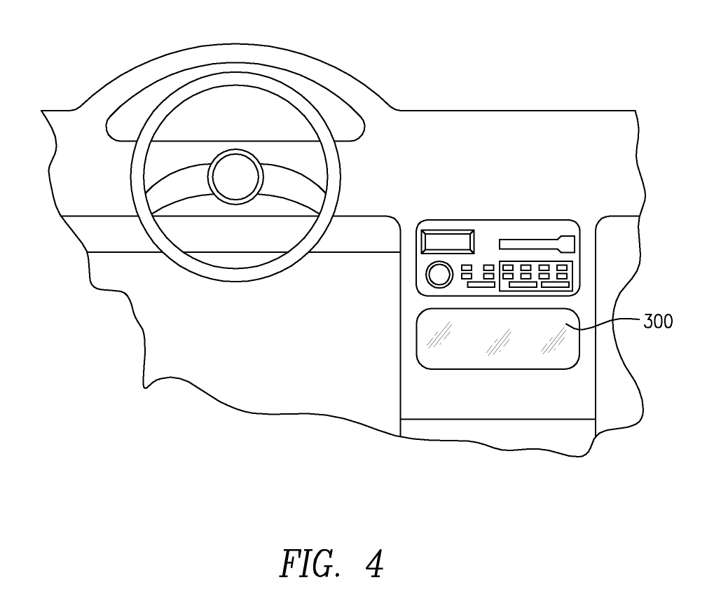

FIG. 1 shows a display device system 1000 of the present invention. The system includes a digital display 100, a receiving port 200. In some embodiments the digital display system 1000 includes a controller 300 as shown in FIGS. 3 and 4. The digital display 100 is an LCD screen that has dimensions of a standard government issued license plate such as 12″×6″. The digital display, however may have other dimensions depending on the type of vehicle to which the system 1000 is attached, for instance if a motorcycle is used. The display 100 is designed to display digital images or messages.

The display 100 is waterproof as it is encased in polypropelyne to prevent water from destroying the internal components in said display 100. The rear of the display 100 includes a mounting device comprising a brace 110 and a male-mount 120. Said brace 110 has a length and said male-mount 120 is slideably connected to said brace 110. The male-mount 120 may be positioned anywhere along the length of the brace 110 from a first end to a second end on said brace 110. In one embodiment the male-mount 120 has electrical contacts 122. In an alternative embodiment, the digital display 100 may be battery powered.

The receiving port 200 may be disposed on the front end of a vehicle such as a bumper of a vehicle. In one embodiment the port 200 is flush with and integrated into the bumper. See FIG. 3. In another embodiment, the receiving port 200 is attached to and rests on the surface of the front bumper. In yet another embodiment, the port 200 is integrated into the bumper to receive the digital display 100 and will be concealed behind a plastic screen. In this embodiment, the port 200 may be assembled by cutting the bumper with a template in the size of the digital display 100, cutting Styrofoam behind the bumper to nestle the port 200 and attaching or clipping a polycarbonate cover into the inside of the bumper to shield the digital display 100 from environmental conditions or theft.

The receiving port 200 is dimensioned and configured to receive the male mount 120. Once the digital display 100 is received in the port 200, the user of the system 1000 may arrange the digital display 100 at any position with respect to the position of the port 200 on the bumper. The receiving port 200 has corresponding electrical contacts 222 which are designed to connect with the electrical contacts 122 of the male-mount 120. See FIG. 1. In one embodiment the receiving port 200 is electrically connected to the engine E of the vehicle to provide power to the corresponding electrical contacts 222 of the port 200. Upon placing the male-mount 120 in the receiving port 120, the corresponding electrical contacts 222 connect with the electrical connects 122 of the male-mount 120 to provide power to the digital display 100. In the embodiment where the display 100 is battery powered, the port 200 would not require contacts 222 and would serve to support/position the display 100.

The ability to remove the digital display 100 from the port 200 provides the user of the system 1000 with an option of leaving the display 100 on the port 200 or removing the display 100 from the port 200 when the vehicle is not in use. Thus, the invention provides an anti-theft feature to the system 1000. When said digital display 100 is removed from said port 200, a protective cover may be placed over the contacts 222 to protect said contacts 222 from environmental elements. In another embodiment, the electrical contacts 222 may be selectively exposed by a protective cover only when said male-mount 120 is disposed in the port 200.

The display device 100 is used to display digital messages, pictures and vehicle registration information as directed by the user of the system 1000. Examples of messages that may be displayed on the display device 100 include sports scores, advertisements, personal messages, examples of pictures that could be displayed on the display 100 include photographs, team logos, company logos. The user of the system 1000 can also decide to display the digital vehicle plate number that is assigned to the vehicle, which may be pre-programmed into the system 1000 and will be a default image displayed on the display 100. Receipt of such vehicle information may be downloaded from authorized state issuing agencies and will be locked and uneditable. In another embodiment, the digital display 100 may display vehicle identification information specific to the vehicle to which the digital display 100 is attached by reading read said vehicle specific information off of a chip disposed on said port 200.

The digital information displayed on the display 100 may be customized by the user of the system 1000. In one embodiment, a controller 300 may be used to manage information displayed on the display 100. The controller 300 may serve as the control center of the system 1000 providing options for the user to display pictures, video, license plate information, etc. on the display 100. Management features will be in place to prevent the display of explicit messages, photos and video. The controller 300 may be a touch screen device that serves as a data receipt device and as a input device for entering data that will be sent to and displayed on the display 100 by manual entry or by receiving information from an SD card, or via devices that can be connected using a USB connection. The controller 300 may be a four inch touch-screen with 8 GB of memory. In an embodiment, the controller 300 is Bluetooth ready, may have smart phone application controls and a LINUX operating system. The controller 300 may be electrically communicable with the display 100 and may be powered by the engine E or independently powered by batteries or the like. In an alternative embodiment, the digital display 100 may include a computer for managing information and thus preclude the need for a controller. In another alternative embodiment, the digital display 100 and the controller 300 may be wirelessly communicable forgoing the need to hardwire the controller 300 and display 100 together.

The present invention is not to be limited in scope by the specific embodiments described herein. Indeed, various modifications of the invention in addition to those described herein will become apparent to those skilled in the art from the foregoing description and accompanying Figures. Such modifications are intended to fall within the scope of the appended claims.

1. An attachment system comprising:
a display device, said display device having a mounting device on a rear surface of said display device, said mounting device including a brace and a male-mount, said male-mount being slidably connected to said brace wherein said male-mount may be positioned anywhere on said brace; and
a female receiving port, said female port being dimensioned and configured to receive said male-mount of said display device;
wherein said male-mount is releaseably connectable to said female receiving port.

2. A system for attaching a digital display device to a vehicle comprising:
a digital display device, said digital display device having a mounting device on a rear surface of said digital display device, said mounting device including a brace and a male-mount, said male-mount is slidably connected to said brace; and
a female receiving port, said female port being a power port, said female port being disposed on a vehicle, said female port being dimensioned and configured to receive said male-mount of said digital display device;
wherein said male-mount is releaseably connectable to said female receiving port,
wherein, when said male-mount is connected to said female port, said digital display can be selectively powered on and off.

3. The system of claim 2, wherein said female port is powered by batteries.

4. The system of claim 2, wherein said female port is connected to an electronic unit of said vehicle.

5. The system of claim 2, wherein said male-mount may be positioned anywhere on said brace.

6. The system of claim 2, wherein said brace has a length, said male-mount may be positioned anywhere along said length of said brace.

7. The system of claim 2, wherein said digital display device is encased in polyproylene.

8. The system of claim 2, wherein said digital display device is watertight.

9. The system of claim 2, wherein said female port is disposed on a bumper of said vehicle.

10. The system of claim 2, wherein said female port is integrated in a front bumper of said vehicle.

11. The system of claim 2, wherein said digital display device is 12″ by 6″.

12. The system of claim 2, wherein said digital display device is an LCD screen having dimensions of a standard state issued license plate.

13. The system of claim 2, further comprising a controller, said controller managing displays shown on said digital display device.

14. The system of claim 11, wherein said displays shown on said digital display device include digital images.

15. The system of claim 2, further comprising a controller, said controller having a memory, said controller managing displays shown on said digital display device.

16. A digital display device system comprising:
a display device, said display device having a mounting device on a rear surface of said display device, said mounting device including a brace and a male-mount, said male-mount being slidably connected to said brace; and
a female receiving port, said port being dimensioned and configured to receive said male-mount of said display device, said female receiving port being electrically connected to an engine of a vehicle; and
a controller, said controller being communicable with said digital display,
wherein said male-mount is releaseably connectable to said female receiving port, and
wherein said male-mount may be positioned anywhere on said brace.

17. The digital display device system of claim 16, wherein the male-mount has electric contacts and the female receiving port has corresponding electric contacts, said electric contacts being connectable with said corresponding electric contacts, wherein said digital display is powered on when said vehicle is on.

18. The digital display device system of claim 16, wherein the digital display displays digital information.

19. The digital display device system of claim 18, wherein the digital information includes digital messages, digital photos and digital video.

20. The digital display device system of claim 18, wherein the digital information displays vehicle identification information specific to the vehicle to which the system is attached.
